(19) United States
(12) Patent Application Publication
(10) Pub. No.: US 2009/0235831 A1
(43) Pub. Date: Sep. 24, 2009

(54) Self-Cleansing Juicer System

(76) Inventor: Arthur Nisonov, Rego Park, NY (US)

Correspondence Address: LILLIE LAW, LLC, 269 SOUTHPORT ST, RONKONKOMA, NY, 11779, US

(21) Appl. No.: 12/050,401

(22) Filed: Mar. 18, 2008

(51) Int. Cl. B30B 9/06; B02C 25/00; A23N 1/00

(52) U.S. Cl. 100/112; 99/486; 99/510

(57) ABSTRACT

A self-cleansing juicer system comprising a supply hose having a proximal and distal end, wherein the distal end provides for removeably connecting to an opening in the cover of the juicer; and the proximal end provides for removeably connecting to a water supply; the cover having an exit-outlet for byproduct to pass therethrough, wherein the outlet is configured and dimensioned for removeably connecting to an exit hose for carriage of byproduct to a desired location; and an adjustable feature on the collection bowl discharge for selectively setting a desired flow rate of product discharge.

### FIELD OF THE INVENTION

The present invention is directed towards fostering a healthy fruit and vegetable diet and to other fruit and vegetable juicers, more particularly, to a juicing system having a self-cleaning apparatus that effectively and efficiently purges residue and dried pulp (aka byproduct) out, yielding a clean, fresh, and ready to use juicer.

### BACKGROUND OF THE INVENTION

It is recognized that in today's world a healthy diet goes a long way. A fruit and vegetable juice extractor is the first step; however, the time burden of cleaning a juice extractor and purging the remainder byproduct out of the system turns many a potential user away from an improved diet, hence the need for an improved system.

Historically, juice extractors are powered by an electric motor that is enclosed in a plastic covering to prevent shock or other unnecessary disturbances. The motors axle is extended out of the plastic enclosure and is attached to a rotating shredding disk, having a tube like passageway so that when fruits or vegetables are pushed through they come in contact with the grating disk for rasping. Once rasped or shredded, it is squeezed on a conical shaped filter encircling the grating disk. Around the conical disk is a plastic opening for the raw fruits or vegetables when squeezed it is directed to an external drinking cup. Some of the pulp that is left over and is not allowed through by the filter, is pushed out from the top of the spinning disk into another opening and out into a trash bowl.

The most common problem in such juice extractors is that the byproduct clogs the filter which is difficult to remove. It also reduces the efficiency for making other kinds of juices within an interval of quite a few minutes unless the pulp (byproduct) is totally purged from the filter. In U.S. Pat. No. 5,421,248 issued to Hsu, an assembly of filter residue removal equipment is illustrated. First, the mechanical complexity of the structure; secondly, even though the stopper is accurately positioned at a certain time to push all the residue up, it still leaves most of the residue stuck on the filter which then ultimately dries and hardens which compounds the issue and essentially creates much dreaded work. Nonetheless, it still needs to be disassembled to be washed by hands which is time consuming. This typically leads to discouragement and eventually abandonment of the juicers and ultimately users return to purchasing juices from stores, and/or unhealthy or at least to a less healthy diet.

Another example is illustrated in U.S. Pat. No. 4,506,601 to Ramirez, an improvement over Hsu; works on a basic principle of centripetal force, this pushes the shredded pieces through the conical filter, because of the conical shape and through a series of vain-like paths, the leftovers are forced upward and into the collection bowl. However, Ramirez still lacks the ability to remove the pulp from the filter and the inner parts of the juicer, leading to the same issues and outcomes encountered by Hsu hereinabove.

Contemporarily, juice extractors, although they may extract juices effectively, are all faced with one problem: how to purge the byproduct about the top cover, and most importantly around the conical filter where the heart of juice extraction lies. Hence lies the need for a speedier, less messy, and increased efficient method of cleaning a juicer.

### SUMMARY OF THE INVENTION

The present invention provides an affordable fruit and vegetable juicer in which the residue and the byproduct via a water source may be automatically cleaned from the filter and the inner parts of the juicer absent the hassle of manually unclogging the filter.

Furthermore, the present invention, provides a fruit and vegetable juice extractor system having a cover that accommodates any external water source to be inserted into the machine, and also an external drainer for the byproduct to discharge into the sink.

Once the raw material is prepared, e.g., the fruit or the vegetable, it is inserted into the outer orifice or the mouth, proceeding down the tube and into the grater, whereon one side the juice exits and from the other the residue exits. In order to purge the residue, the external mouth of the juicer, where the juice exits, is connected to the residue bowl via a rubber kitchen hose, and is positioned into the sink. Pressurized water will enter the top, supplied from any source (kitchen sink, lavatory sink and etc.) and passed through all of the inner parts of the juicer. As such, it is directed onto the filter to forcefully purge the byproduct out into the sink via the drainer hose. Once the process is completed, the hose is removed, and the juicer is ready for the next juicing, virtually hassle free.

Other objectives, advantages, and novel features of the present invention will become more apparent from the following detailed description when taken in conjunction with the accompanying drawings.

### BRIEF DESCRIPTION OF THE DRAWINGS

The following drawings in which like reference characters indicate like parts, are provided for illustration of the invention and are not intended to limit the invention in any manner whatsoever.

FIG. 1 is a side cross-sectional view of one embodiment of the present invention;

FIG. 2 is an elevational view of the top cover;

FIG. 3 is a top view of the top cover of the juicer; and

FIG. 4 is an exploded compilation view of the self cleaning juicer with the self cleaning components.

### DESCRIPTION OF THE PREFERRED EMBODIMENT(S)

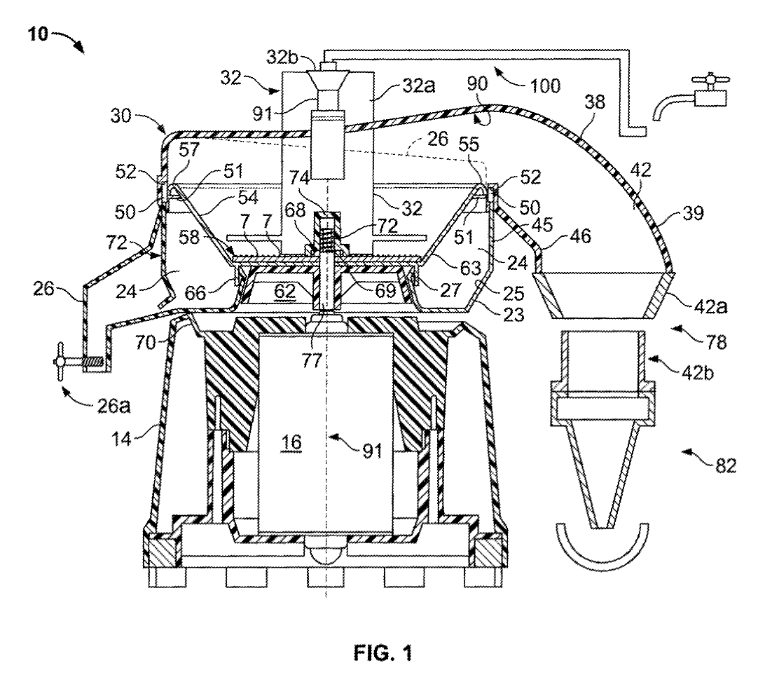

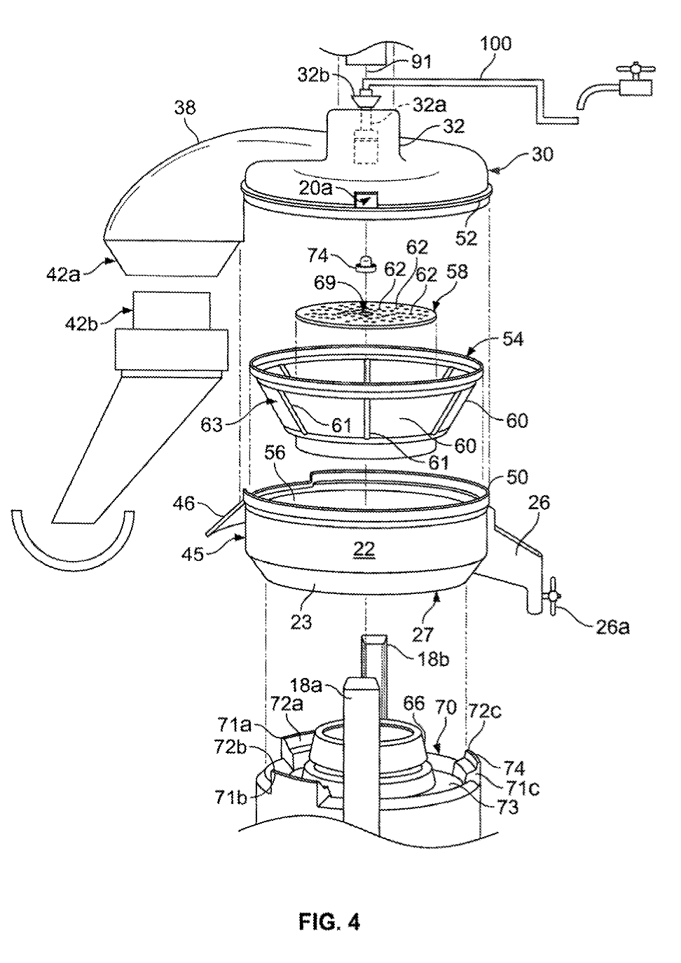

The following descriptions of the preferred embodiments are presented to illustrate the present invention and are not to be construed to limit the claims in any manner whatsoever. Referring generally to FIGS. 1 through 4, the present invention is illustrated. In one embodiment, the self cleansing juicer system 10 comprises a cover 30 and a feeding tube 32 connected via an outer orifice to place the fruits and/or vegetables (hereafter raw material), a collection bowl 22, and a top supporting portion 52 which when connected attaches to a collection bowl orifice 56. The self cleansing juicer system 10 has dual attachments 18a, 18b respectively, located on the right and the left side of the juicer combining the top portion 52 with the collection bowl 56. A power cord 12 attached to the motor covering base 14 of the juicer system 10 is wired to the electric motor 16, illustrated in FIG. 1, and optionally may include a timer (not shown). The collection bowl discharge 26 provides a tube like passage to the liquid receptacle subjectively selected by the user, for example, a glass, or cup for the extracted juice (aka product) that builds up in the chamber 24 and an open/close valve or stop cock 26a for the water not to escape when washing is in progress. It is envisioned that the valve may be adjusted by the operator to a desired setting, such as completely open, completely shut, or something in between.

The top cover 30 of the juicer system 10 includes a feeding tube 32 that provides a passage for the incoming raw material to be extracted, wherein the raw material is forced to enter by the pusher 34. The top cover 30 also includes an opening 32a for the external hose 100 to be attached via distal end 32b, wherein the proximal end 32c of the hose 100 provides means for removably connecting to a water supply. Alternatively, the hose 32b may be configured and dimensioned be operatively connected via the feeding tube 32. The top cover 30 is configured and dimensioned such that water emanating from 32a will have sufficient pressure to force the byproduct out from exit-outlet 42, for example, tap water pressure of no more than 150 psi, preferably between 50 to 70 psi, although it is envisioned that high pressures may be used. Exit-outlet 42 is attached with a special V-shaped opening 42a that inter-locks with an exit hose 42b which carries the waste or byproduct, inter alia, dried pulp, out and into the sink.

The motor covering base 14 of the juicer system 10 has a collection bowl supporting surface 70 and supporting flanges 71a, 71b, and 71c, which is configured and dimension such that the bowl 22 remains stationary when the motor 16 spins. The collection bowl 22, houses the grading/filter basket 54 which is conical in shape, wherein said bowl 22 has a bottom orifice 27 for connection with the filter basket support 66, which has a center mounting configuration 68, from which a screw rod 72 extends vertically. The collection bowl 22 has a top extending overhang 56 through which the conical grading/filter basket 54 is fastened on the filter basket support 66.

The filter basket 54 has side net-like walls 63 to function as a filter, and it is preferred to be conical in shape so as to optimize performance. When the raw material is graded, it is pressed against the filter basket wall 63 to secrete all the juices (product) out into the chamber 24. The supporting structures 61 enables firmness and durability to the grading/filter basket 54. The grading/filter basket 54 contains a lower segment 53 attached to the side walls 63. The lower segment 53 harnesses the grating disk 58, and a center hole 69. The screw rod 77 having a threaded end 72 passes through the center hole 69 of the grating disk 58, through the center hole 67 of the filter basket 54, wherein a cap nut 74 is threaded onto the screw rod 77 to hold together the filter basket 54 and grating disk 58.

A pulp-extraction flange 46 extends from the wall of the collection bowl 22 preventing byproduct from dripping along the outer surface 45 of the collection bowl 22, and to prevent leakage during the washing phase. The right and the left attaching arms 18a, 18b, respectively, have corresponding right and left fastened grooves 20a, 20b, respectively, on top cover 30. The attachment arms 18a, 18b are released by attachment levers 19a, 19b thereby releasing collection bowl 30.

A supporting portion 50 of the collection bowl 22 is configured and dimension such that the bottom surface 42 of cover 30 mates thereto. An extending edge 51 and the extension 54 of the grading/filter basket porous mesh wall 63 spins about its axis 91 for extracting the product from the raw material. The separation of the product from the byproduct, described above, is accomplished, in part, by prohibiting any byproduct from entering the chamber 24 via wall 63 which circumscribes the disk 58, such that when disk 58 spins, any material that is larger than the holes defining the mesh shall not pass therethrough and is hence byproduct.

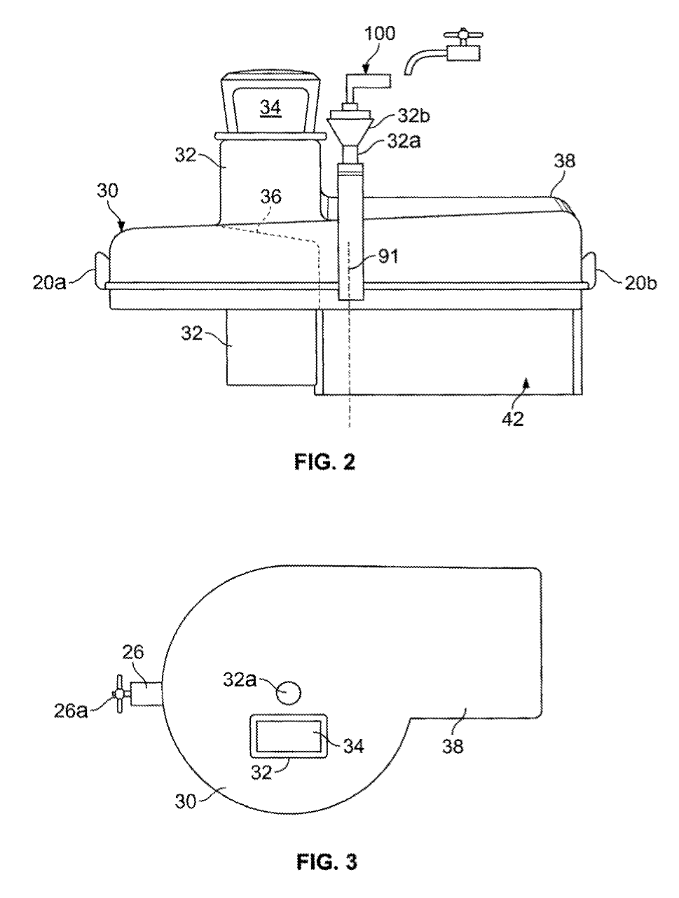

FIG. 2 illustrates the top cover 30, the feeding tube 32, with the fruit and vegetables driver (aka the pusher) 34, which is not located on the central axis 91 On the axis 91 is a cleaning tube 32a which has an adaptor 32b that goes into the cleaning tube with an external supply hose 100 that is connected to a water source for cleaning out the byproduct. FIG. 2 illustrates attachment flanges 20a, 20b, the configuration of cover 30 to the elevation (or apex) 38, wherefrom the interior surface 90 extends horizontally and then downward until it terminates to provide a passageway 42 to direct the byproduct out and away from the juicer system 10.

FIG. 1 illustrates a sectional cutout-view of the self cleaning juicer system 10, with the addition of removal byproduct hose 78. A motor drive 16 is located within the motor covering base 14 which includes the supporting surface for the collection bowl 70. There are also three supporting flanges 71a, 72b, and 71c for the support of the collection bowl 22. The collection bowl 22 bottom surface 23 is slanted which partially defines the inner flange 25 of the juice chamber 24.

The screw rod 77 extends vertically through the filter basket center hole 67 and the grating disk center hole 69, wherein holes 67 and 69 are configured and dimension such that rod 77and the threaded end 72 mate thereto. A cap nut 74 is threading screwed onto the threaded outer end 72 of screw rod 77 to secure the filter basket 54 and the grating disk 58 onto the motor covering base 14.

The top cover 30 is placed over the surface 52 into the groove 57 and into the supporting surface 50. The side wall extension 55 is configured and dimensioned so as to allow the filter basket 54 to spin while providing stability between the filter basket 54, and top cover 30, and also includes an opening 32a for the external hose 100 to be attached via fitting 32b, thereby allowing the byproduct to be washed away via water supplied via supply hose 100. The position of the feed tube 32 may be seen as offset from, or behind in this view, the center axis 91 due to the injected water source 32a and 32b. A guide 56 extends from the top surface 50 of the collection bowl 22 to guiding the water and the byproduct away from the outer surface 45 of the collection bowl 22.

All of the above referenced patents; patent applications and publications are hereby incorporated by reference. Many variations of the present invention will suggest themselves to those of ordinary skill in the art in light of the above detailed description. All such obvious modifications are within the full-intended spirit and scope of the claims of the present application both literally and in equivalents recognized at law.

What is claimed is:

1. A self-cleansing juicer system comprising:
a supply hose having a proximal and distal end, wherein said distal end provides means for removeably connecting to an opening in the cover of said juicer; and said proximal end provides means for removeably connecting to a water supply.

2. A self-cleansing juicer system of claim 1, further comprising a first exit hose for carriage of byproduct to a desired location, and being configured and dimensioned to be removeably connected to an exit-outlet of a juicer.

3. A self-cleansing juicer system as in claim 9, further comprising a second exit hose for carriage of at least water to a desired location, and being configured and dimensioned to be removeably connected to the collection bowl discharge of a juicer.

4. A self-cleansing juicer system of claim 1, wherein said system is operatively connected to a water supply having a pressure of no more than 150 psi.

5. A self-cleansing juicer system of claim 1, wherein said system is operatively connected to a water supply having in the range of about 50 to about 70 psi.

6. A self-cleansing juicer system of claim 1 wherein said system is used in while the motor of a juicer is in a mode selected from the group consisting of on, and off.

7. A self-cleansing juicer system of claim 1, wherein said removable means is selected from the group consisting of a quick connector, and threaded means.

8. A self-cleansing juicer system of claim 1 wherein said system includes a sanitizer.

9. A self-cleansing juicer system of claim 3, wherein said second exit hose includes an adjustable means is for selectively setting a desired flow rate of product discharge.

10. A self-cleansing juicer system of claim 1, which further includes a timer which controls a member selected from the group consisting of: water supply, and motor.

11. A self-cleansing juicer system of claim 2, which further includes a timer which controls said first exit hose.

12. A self-cleansing juicer system of claim 3, which further includes a timer which controls said second exit hose.

13. A self-cleansing juicer system comprising:
a juicer having a top cover with a feeding tube therethrough, and an opening therein, and supply hose having a proximal and distal end, wherein said distal end provides means for removeably connecting to said opening; and said proximal end provides means for removeably connecting to a water supply, which optionally further includes a timer which controls a member selected from the group consisting of: water supply, and motor of said juicer.

14. A self-cleansing juicer system of claim 13, further comprising a first exit hose for carriage of byproduct to a desired location, and being configured and dimensioned to be removeably connected to an exit-outlet of a juicer, and optionally, a timer for controlling said first exit hose.

15. A self-cleansing juicer system as in claim 13, further comprising a second exit hose for carriage of at least water to a desired location, and being configured and dimensioned to be removeably connected to the collection bowl discharge of a juicer, and optionally, a timer for controlling said second exit hose.

16. A self-cleansing juicer system of claim 13, wherein said system is operatively connected to a water supply having a pressure of no more than 150 psi.

17. A self-cleansing juicer system of claim 13, wherein said system is operatively connected to a water supply having in the range of about 50 to about 70 psi.

18. A self-cleansing juicer system of claim 13, wherein said removable means is selected from the group consisting of a quick connector, and threaded means.

19. A self-cleansing juicer system of claim 13, wherein said system includes a sanitizer.
